(19) United States
(12) Patent Application Publication
(10) Pub. No.: US 2007/0256986 A1
(43) Pub. Date: Nov. 8, 2007

(54) Chemically-enhanced mechanical treatment of water

(76) Inventors: Freddie L. Singleton, Switzerland, FL (US); Michael J. Mayer, Jacksonville, FL (US); Alexander W. Breen, Richmond Hill, GA (US)

Correspondence Address: Joanne Mary Fobare Rossi;Hercules Incorporated, Hercules Plaza, 1313 North Market Street, Wilmington, DE, 19894-0001, US

(21) Appl. No.: 11/641,437

(22) Filed: Dec. 19, 2006

Related U.S. Application Data
(60) Provisional application No. 60/752,170, filed on Dec. 19, 2005.

(51) Int. Cl. C02F 1/50; B01D 21/01

(52) U.S. Cl. 210/764

(57) ABSTRACT

The present invention describes a method of treating an aqueous system with a hydrodynamic water treatment device in conjunction with polymeric material.

### CROSS REFERENCE TO RELATED APPLICATIONS

This application is related to U.S. patent application Ser. No. 60/752,170, filed Dec. 19, 2005, from which priority is claimed, the foregoing application is hereby incorporated by reference.

### TECHNICAL FIELD

The present invention relates to using polymeric chemicals to enhance inhibition of microorganisms by a hydromechanical treatment device to inhibit or control growth of microorganisms in aqueous systems, more particularly in industrial process waters.

### BACKGROUND OF THE INVENTION

In the absence of extreme environmental conditions, microorganisms are ubiquitous in natural and man-made aqueous systems. The size and complexity of a microbial community in an aqueous system will depend on many factors such as availability of nutrients, temperature, pH, etc. Many types of industrial water systems provide an environment suitable for growth of bacteria and other types of microorganisms. When conditions allow for uncontrolled growth of microorganisms, the result is large numbers of free-floating (planktonic) cells in the water column and sessile cells on submerged surfaces where conditions favor formation of biofilms.

Regardless of the system, whether natural or man-made, growth of microorganisms in aqueous systems can have serious consequences. For example, problems caused by uncontrolled microbial growth can range from interference of important industrial processes to degradation and/or spoilage of products to contamination of products. Growth of microorganisms on surfaces exposed to water (e.g., recirculation systems, heat exchangers, once-through heating and cooling systems, pulp and paper process systems) can be especially problematic. Microbiologically-influenced problems in industrial process waters include accelerated corrosion of metals, accelerated decomposition of wood and other biodegradable materials, restricted flow through pipes, plugging or fouling of valves and flow-meters, and reduced heat exchange or cooling efficiency on heat exchange surfaces. Biofilms may also be problematic relative to cleanliness and sanitation in medical equipment, breweries, wineries, dairies and other industrial food and beverage process water systems.

In order to control problems caused by microorganisms in industrial process waters, numerous antimicrobial agents (i.e., biocides) and other compounds, especially surface-active materials (e.g., surfactants) have been employed. Because of safety and health concerns as well as cost and other considerations, alternatives to biocides have been investigated. Surfactants have been used as surface cleaners or dispersants because of their ability to remove chemical and/or biological deposits from surfaces. When used as a cleaner or dispersant, surfactants are usually added directly to a process water stream or to a material used in the process. The typical method of addition is such that the surfactant is distributed within a certain region of the process system to either clean surface or prevent the surface from being contaminated with chemical or biological materials.

Technologies that do not include using biocides or other chemical to control microorganisms in industrial process waters have also been the subject of investigation and development. Many non-chemical water technologies have been developed and the general categories for such technologies include ultraviolet light and ozone (for disinfecting water), ultrasound (or sonication), electric and electromagnetic fields, including pulsed electrical fields, and hydromechanical, among others.

Hydro-mechanical water treatment is based on the premise that changes in the chemical composition and other physico-chemical parameters of water occur during treatment. One such technology, marketed by VRTX Technologies, (San Antonio, Tex.) is based on inducing chemical changes in water via hydrodynamic cavitation. This technology treats industrial process waters, primarily in cooling towers to prevent corrosion, scale formation, and deposition.

Hydrodynamic cavitation refers to a process wherein cavities and cavitation bubbles filled with a vapor-gas mixture are formed inside the fluid flow. Cavitation bubbles can also be formed at the boundary of a baffle body because of a local decrease in pressure in the fluid. A great number of vapor-filled cavities and bubbles form if the pressure decreases to a level where the fluid boils. As the fluid and cavitation bubbles flow in a system, they encounter a zone with higher pressure at which point, vapor condensation occurs within the bubbles and the bubbles collapse. The collapse of cavitation bubbles can cause very large pressure impulses. For example, some pressure impulses within collapsing cavities and bubbles can be tens of thousands of pounds per square inch. The result of hydrodynamic cavitation and other forces exerted on the water range from changes in solubility of dissolved gases to pH changes to formation of free radicals to precipitation of some dissolved ions (e.g., calcium, iron, and carbonate).

Systems designed to induce hydrodynamic cavitation in fluids traditionally have been used as homogenization devices or colloidal mills. Examples of homogenization devices have been described by Ashbrook et al. (U.S. Pat. Nos. 4,645,606; 4,764,283; 4,957,626), Ashbrook (U.S. Pat. Nos. 5,318,702; 5,435,913). Kozyuk (U.S. Pat. Nos. 6,802,639 and 6,502,979) discloses a homogenization device that forms emulsion or colloidal suspensions that have long separation half-lives by use of cavitating flow. Thiruvengadam et al, (U.S. Pat. No. 4,127,332) discloses a system for homogenizing a multi-component stream including a liquid and a substantially insoluble component, which may be either a liquid or a finely divided solid.

A hydromechanical water treatment system based on hydrodynamic cavitation can be used to inhibit or kill macroorganisms and microorganisms in an aqueous system as a result of high shear, hydrodynamic cavitation forces, and other hydrodynamic changes in the aqueous system as it passes through the treatment system. Relative to microorganisms, e.g., bacteria and fungi, the shear and hydrodynamic forces can cause lysis of the cells. Most methods used to lyse bacterial and fungal cells are based on cavitation and shear effects. For example, ultrasound has been used to induce cavitation in liquids and, as a result, lysis of cells occurs. Other mechanical methods used in the past to disrupt cells have included ball mills, the application of high pressure followed by passage through a small diameter orifice, and violent vibration with inert particulates. These and other methods to physically disrupt microbial cells are described by Schnaitman, C. A., “Cell Fractionation,” Manual of Methods for General Bacteriology, Ch. 5, 52-61 (Gerhardt, P. et al., Eds. 1981), Coakley W. T. et al., “Disruption of Microorganisms,” Adv. Microbiol. Physiol. 16:279-341 (1977). Physical disruption of microbial cells is usually used as part of a process to isolate specific cellular components such as protein, nucleic acids, and the like. However, such technologies are not practical for treating large volumes of water usually present in industrial settings.

There remains a need to improve the efficiency of the hydrodynamic devices to control microorganisms in aqueous systems, particularity in industrial process waters.

### SUMMARY OF THE INVENTION

It has surprisingly been found that when polymeric products are used in conjunction with a hydrodynamic-based water treatment system an unexpectedly large increase in the effectiveness of the system is observed. The quantity of microbiological organism in the water being treated by the present invention is greatly decreased as compared to using the hydrodynamic-based water treatment system without the polymeric product.

The present invention provides a method for controlling microorganisms in industrial process waters by treating the water with an effective amount of one or more polymeric products and a hydrodynamic-based water treatment system. Particularly effective polymers in the present invention are cationically charged polymers.

### DETAILED DESCRIPTION OF THE INVENTION

The present invention is directed to using polymeric chemicals in combination with a hydrodynamic water treatment device to inhibit or control the growth of microorganisms in an aqueous system, particularly in industrial water systems.

The hydrodynamic water treatment device is generally operated in the range of 50 to 200 psi, preferably in the range of 80 psi to 140 psi, more preferably in the range of 85 to 120 psi.

The flow rate will depend on the hydrodynamic water treatment device used. The flow rate can be as low as 50 gpm. The flow rate can be as high as 1500 gpm. The flow rate of the hydrodynamic water treatment device, in generally, is in the range of about 80 to 1000 gpm. The flow rate is based on the hydrodynamic water treatment device, its configuration, the pumps, the chamber of the device and the orifice setting of the device.

The water being treated is generally recycled through the hydrodynamic water treatment device. The water is recycled through the hydrodynamic water treatment device a number of times to achieve the desired microorganism inhibition. The number of passes through the hydrodynamic water treatment device depends on the level and kind of microorganisms in the aqueous system being treated and the desired percent of inhibition. Some systems have only a few passes through the system to achieve acceptable level while other aqueous systems require a higher number to passes through the hydrodynamic water treatment device. Generally it is desirable to have the number of passes less than 100, even more desirable is to have the number of passes less then 50, and most desirable is to have the number of passes less than 30.

In one embodiment of the present invention, the amount of polymer added to a water system is in the range of 0.01 to 10,000 mg per liter, preferably in the range of 0.1 to 10 mg per liter. The amount of polymer can be as high as 10,000 mg per liter, preferable up to 100 mg per liter or more preferably up to 10 mg per liter. The amount of polymer is at least 0.01 mg per liter, preferably at least 0.1 mg per liter.

The use of the polymeric chemicals in conjunction with the hydrodynamic water treatment device increases the effectiveness of the hydrodynamic water treatment device.

It is believed that the hydrodynamic water treatment device produces the cavitation and/or increased shear in the water passing through the hydrodynamic water treatment device resulting in an inhibitory hydrodynamic effect wherein the microorganism are inhibited or killed.

As used herein, “inhibition” or “inhibit” refers to affecting microorganisms in a manner to render them unable to maintain viability, grow, reproduce, carryout normal metabolic activities, or adversely affect an industrial process water, the process for which the water is used, or the product produced.

For the purpose of the present invention, a hydrodynamic water treatment device is defined as a device designed to treat water by eliciting changes in one or more physico-chemical parameters of industrial process water by subjecting said water to high pressure and/or low pressure, and /or high flow rate, and/or high shear forces. The result of said treatment is changes in one or more parameters such as chemical composition, pH, temperature, concentration of dissolved gases, and number of viable microorganisms. The hydrodynamic water treatment device treats water by subjecting the water to hydrodynamic cavitation and/or high shear forces by pumping the water through components of the devise under conditions of high flow rate and pressure changes. It is understood that one or more of the conditions needed for hydrodynamic cavitation to occur also could be exploited as the basis for the invention described herein; such conditions include subjecting the liquid to regions of high pressure and low pressure while flowing at a high rate. It is also understood that high shear forces will be generated because of high flow rate and the nature of the device used.

As used herein, the term “microorganism” refers to any unicellular (including colonial) or filamentous organism. Microorganisms include all prokaryotes, fungi, protozoa, and some algae.

As used herein, “industrial process water” or “industrial water system” means water contained in recirculation and once through systems such as heat exchangers, heating and cooling systems, pulp and paper process systems, milk and dairy processing systems, food processing systems, and wastewater systems. It is obvious to one trained in the art that water contained in non-industrial systems could be also be treated according to the invention described herein. Such systems include, but are not limited to, aquatic systems such rivers, lakes, ponds, irrigation and retention ponds, fishponds, millponds, impoundments, lagoons, fountains, and reflecting and swimming pools. Pulp and paper process systems include, but are not limited to, whitewater, clarification units, wastewater treatment, intake water, either from a natural source(lake or stream) or public water source, and makedown water.

Generally, the polymers useful in the present invention, used by themselves, are not known to provide any substantial inhibition of microbiological organisms. However, used in conjunction with a hydrodynamic water treatment device, the polymers greatly enhance the effectiveness of the hydrodynamic water treatment device in controlling or killing the microorganisms.

The present invention provides a method of treating water systems, particularly industrial water systems to inhibit or kill microbiological growth. The method comprises treating the industrial water with a hydrodynamic water treatment device and contacting the industrial water with a polymeric material, preferable a cationic polymeric material. In one embodiment the polymeric material is added to the industrial water prior to treating the water with the hydrodynamic water treatment device.

The polymeric material can be added at intervals during the treatment of the water with the hydrodynamic water treatment device. In one embodiment the polymeric material are added to the water being treated with the hydrodynamic water treatment device at discrete intervals during the treatment.

In one embodiment of the invention the polymeric material is added to the water being treated both before the treatment with the hydrodynamic water treatment device and at discrete interval during the treatment of the water.

The polymeric material can be added continuously to the water being treated during the treatment of the water with the hydrodynamic water treatment device.

The polymeric material is present in the water being treated while the water is being treated by the hydrodynamic water treatment device.

In one preferred embodiment of the present invention the polymeric material comprises a cationic polymer. The cationic polymer of the present invention can have a molecular weight between about 100 and 10,000,000 daltons, preferably between 1,000 and 500,000, more preferable between 5,000 and 200,000 daltons.

Polymeric compounds that can be used with a hydrodynamic water treatment device include cationic polymers. Any cationic polymer or mixture thereof can be used and preferably, conventional cationic polymers commonly associated with papermaking can be used in the present invention. Examples of cationic polymers include, but are not limited to, cationic starches, cationic guar, and polymers selected from the group consisting of: polyethylene imine, polyamines, polycyandiamide formaldehyde polymers, amphoteric polymers, diallyl dimethyl ammonium chloride polymers, diallylaminoalkyl(meth)acrylate polymers, and dialkylaminoalkyl(meth)acrylamide polymers, a copolymer of acrylamide and diallyl dimethyl ammonium chloride, a copolymer of acrylamide and diallyaminoalkyl(meth)acrylates, a copolymer of acrylamide and dialkylaminoalkyl(meth)acrylamides, and a polymer of dimethylamine and epichlorohydrin.

### EXAMPLES

The “Experimental test system” used in the examples refers to a system comprised of a container or reservoir connected to a hydrodynamic water treatment device, “the VRTX” system via conduits for flow of a liquid from the reservoir to the hydrodynamic water treatment device and back into the reservoir.

The reservoir used in the studies reported herein was a polypropylene tank with a capacity of approximately 300 gallons. An opening near the bottom of the reservoir allowed it to be connected to the VRTX system via a 2-inch diameter pipe. Water exiting the VRTX system was returned to the reservoir via a 3-inch diameter pipe. To increase agitation of water in the reservoir, a submersible pump was placed in the middle of the reservoir. Water entered the submersible pump through the bottom and exited via a port on the top of the pump in an upward direction. The flow rate of the VRTX system was 80 gallons per minute (gpm). As described below, 80 gallons of water were used in each experiment. Therefore, for example, treating the water for 10 minutes allowed the total volume to pass through the hydrodynamic water treatment device 10 times.

As used herein, “VRTX system” refers to a non-chemical water treatment system available from VRTX Technologies, LLC (San Antonio, Tex.). The VRTX system is a hydrodynamic water treatment device and is based on a proprietary design whereby the intake stream of water is divided into two streams that enter a “reaction” chamber via nozzles that impact specific flow characteristics to the water streams. The chamber is designed to allow the water streams to enter from opposing points and collide in the center of the chamber. Because of the design of the nozzles and chamber, the water is subjected to hydrodynamic cavitation and high shear forces. The VRTX system used in the studies reported herein was one optimized for chemical treatment of industrial waters and, as such, the effect on microorganisms was less than if biological treatment of the water was an objective. It is obvious to one skilled in the art that there are other manners to induce hydrodynamic cavitation and high shear forces in order to treat water or other fluids.

As used herein, “basal salts solution” refers to solution prepared by first adding 15 ml of concentrated H₂SO₄ to 500 ml deionized water. The following chemicals were then individually dissolved in the dilute acid solution—KH₂PO₄ (6.0 g), MgSO₄ (1.2 g), AlKSO₄ (3.0 g), FeSO₄ (0.3 g), ZnSO₄ (0.3 g), and NaCl (1.5 g). Deionized water was added to increase the volume to 1.0 liter.

As used herein, “chemically defined water” means water used in the experimental test system prepared in the following steps: (1) filling the reservoir with 80 gallons of tap water; (2) neutralizing the residual chlorine by adding a minimal quantity of Na₂SO₃; chlorine was measured using the Hach DPD Chlorine Test Kit (3) adding 1000 ml of basal salts solution; and (4) adjusting the pH of the water to 7.3 (+ or −0.2 pH unit) by adding 20% NaOH solution.

The Hach DPD chlorine test (Hach Company, Loveland, Colo.). Total available chlorine refers to the amount of chlorine in a sample that reacts with N,N-diethyl-ρ-phenylenediamine oxalate, the indicator used in the Hach assay. To determine the amount of chlorine in a sample, an aliquot of the sample is transferred to a clean container, diluted with deionized water, as appropriate, and assayed according to the Hach DPD chlorine test. The assay measures the total amount of chlorine that can react with the indicator reagent. The reaction is measured by determining the absorbance of light at 530 nm.

Following preparation of the chemically defined water, bacterial cells were added to an initial population density of approximately 1×10⁶ cells per milliliter. Unless otherwise noted, Eschedchia coli was used as the test species in the examples. In some experiments, papermill whitewater was used in lieu of the basal salts-tap water solution; when whitewater was used, the bacteria present in the water at the time of collection were used as the test species.

After the bacteria were added to the basal salts solution and allowed to circulate for 10-20 minutes to become evenly distributed in the water, a 1000 ml sample was aseptically collected and used as the control. This sample was maintained at room temperature on a magnetic stirrer and agitation was provided with a magnetic stir bar.

The efficacy of the treatment programs was determined of the basis of changes in numbers of bacteria before and after the treatment program. Changes in numbers of bacteria were determined by employing the standard plate count technique. Samples of water were aseptically collected and serially diluted in 0.85% saline dilution blanks. One tenth milliliter samples of appropriate dilutions were aseptically transferred to tryptic soy agar plates and evenly distributed over the surface of the agar with a sterile bent glass rod. The agar plates were then incubated for 48 hours at 37 C before the colonies were counted. The number of colonies is representative of the number of viable bacteria in the original water sample. The number of colonies is referred to as the “plate count” and is expressed as the number of colony-forming units (CFUs). In a typical experiment, the serial dilutions ranged from 10⁻² to 10⁻⁶. In all experiments, triplicate culture plates were prepared for each of three dilutions. Population sizes are reported as the average of the three plate counts.

The effect of the different treatment programs was determined based on percent difference in plate counts before and after treatment. Percent differences were calculated according to the equation:

$$\% change = \frac{( Plate count before treatment - Plate count after treatment )}{Plate count before treatment} \times 100$$

As used herein, “initial population size” refers to the number of bacteria per milliliter as determined by the plate count technique in the chemically defined water immediately before testing commenced.

As used herein, “final population size” refers to the number of bacteria per milliliter as determined by the plate count technique in the chemically defined water at the end of testing.

Additions of chemicals to the water were made in an incremental manner after selected treatment times. The amount of a chemical added is expressed in units of parts per million (ppm) (1 ppm=1 milligram per liter). For example, the addition of 1 ppm of a commercially available polymeric compound indicates the presence of 1 mg of said polymeric compound per liter in the total volume of water treated.

The following examples are intended to be illustrative of the present invention. However, these examples are not intended to limit the scope of the invention or its protection in any way. The examples illustrate the synergistic relationship obtained in the present invention.

The hydrodynamic water treatment device used in all the examples is the VRTX 80 (VRTX Technologies, San Antonio, Tex.) The VRTX 80 operates at about 80 gpm, the chamber pressure was about 100 psi. There is a vacuum of about −29 inches of Hg. The back pressure was set at about 2 to 4 psi.

### Example 1

This example demonstrates the effect of the hydrodynamic water treatment device, “the VRTX system”, on the size of the bacterial population in the experimental test system. As illustrated in Table 1, results from three experiments demonstrate the VRTX system has little measurable effect on the bacterial populations. The percent change in the population sizes for the three experiments are within the expected error for this type study.

TABLE 1
Effect of a hydrodynamic water treatment device on the numbers of
culturable Escherichia coli in a chemically defined water system.

| | Concen- | | | | |
|---|---|---|---|---|---|
| | tration(s) | | | | |
| | and | Total | Initial | Final | |
| | Contact | Treatment | Population | Population | Percent |
| Experiment | Time(s) | Time (min.) | Size | Size | Change |
| 1 | NA | 50 | 8.97 × 10⁵ | 9.33 × 10⁵ | 4.01 |
| 2 | NA | 50 | 5.97 × 10⁶ | 5.60 × 10⁶ | −6.20 |
| 3 | NA | 60 | 3.83 × 10⁶ | 4.20 × 10⁶ | 9.66 |

Table 1 shows that there was no significant effect of the hydrodynamic water treatment device, the VRTX system, on population sizes of E. coli in the chemically defined water.

### Example 2

In this example, Perform® PC1290 (Hercules Incorporated, Wilmington, Del.), a polymeric alkylamine-epichlorohydrin, was evaluated for efficacy in the experimental test system. Three 0.5-ppm additions of Perform® PC1290 were made at 10-minute intervals during the study. The results demonstrated that Perform® PC1290 had no significant effect on the E. coli population in the chemically defined water (Table 2). However, when Perform® PC1290 and the VRTX system were used together, the population decreased by 99.47% after the first 0.5 ppm addition of Perform® PC1290. In a subsequent study using lower concentrations of Perform® PC1290 over a longer treatment time (e.g., 30 minutes) similar results (i.e., >97% kill) were obtained although there was a relative significant decrease in the E. coli population (24.94%) in the absence of the VRTX system.

TABLE 2
Changes in population sizes of Escherichia coli in chemically defined
water treated with Perform ® PC1290 with and without the
hydrodynamic water treatment device.

| | | Total | | | |
|---|---|---|---|---|---|
| | Concentration(s) | Treatment | Initial | Final | |
| | and Contact | Time | Population | Population | Percent |
| Treatment | Time(s) | (min.) | Size | Size | Change |
| Perform ® | 0.5 ppm for 10 min., | 30 | 1.20 × 10⁶ | 1.26 × 10⁶ | 5.00 |
| PC1290 | 1.0 ppm for 10 min., | | | | |
| | 1.5 ppm for 10 min. | | | | |
| Perform ® | 0.5 ppm for 10 min. | 10 | 1.20 × 10⁶ | 6.40 × 10³ | −99.47 |
| PC1290 + VRTX | | | | | |
| Perform ® | 0.1 ppm for 5 min., | 30 | 4.17 × 10⁶ | 3.13 × 10⁶ | −24.94 |
| PC1290 | 0.2 ppm for 5 min., | | | | |
| | 0.3 ppm for 5 min., | | | | |
| | 0.4 ppm for 5 min., | | | | |
| | 0.5 ppm for 5 min., | | | | |
| | 0.6 ppm for 5 min. | | | | |
| Perform ® | 0.1 ppm for 5 min., | 30 | 4.17 × 10⁶ | 1.14 × 10⁵ | −97.27 |
| PC1290 + VRTX | 0.2 ppm for 5 min., | | | | |
| | 0.3 ppm for 5 min., | | | | |
| | 0.4 ppm for 5 min., | | | | |
| | 0.5 ppm for 5 min., | | | | |
| | 0.6 ppm for 5 min. | | | | |

### Example 3

In this example, another bacterial species, Pseudomonas aeruginosa, was used as the test species in the experimental test system. This bacterial species is generally recognized as being more difficult to control than most other bacteria. Incremental additions of 0.5-ppm Perform® PC1290 were made during a 35-minute treatment period. The system treated with a total of 1.5 ppm Perform® PC1290 showed a 16.8% decrease in the number of bacteria (Table 3). However, with the VRTX system, 1.5-ppm Perform® PC1290 caused a 45.2% reduction in the bacterial count.

TABLE 3
Changes in population sizes of Pseudomonas aeruginosa in chemically
defined water treated with Perform ® PC1290 with and without the
hydrodynamic water treatment device.

| | | Total Treatment | Initial | Final | |
|---|---|---|---|---|---|
| | Concentration(s) | Time | Population | Population | Percent |
| Treatment | and Contact Time(s) | (min.) | Size | Size | Change |
| Perform ® | 0 ppm for 5 min., | 35 | 8.33 × 10⁶ | 6.93 × 10⁶ | −16.81 |
| PC1290 | 0.5 ppm for 5 min., | | | | |
| | 1.0 ppm for 5 min., | | | | |
| | 1.5 ppm for 20 min. | | | | |
| Perform ® | 0 ppm for 5 min., | 35 | 8.33 × 10⁶ | 4.57 × 10⁶ | −45.14 |
| PC1290 + VRTX | 0.5 ppm for 5 min., | | | | |
| | 1.0 ppm for 5 min., | | | | |
| | 1.5 ppm for 20 min. | | | | |

### Example 4

In this example, additional cationic, amine-containing polymers were evaluated to determine if the efficacies detected in Examples 2 and 3 would be similar for other products. Perform® 1279 (Hercules Incorporated, Wilmington, Del.), a polyquarternary amine-based cationic polymer (molecular weight ˜600,000 daltons), Perform® 8717 (Hercules Incorporated), a poly(dimethyidiallylammonium chloride) (molecular weight ˜500,000 daltons), Perform® 8229 (Hercules Incorporated), a polyquarternary amine-based cationic polymer (molecular weight ˜200,000 daltons), an experimental polyquarternary amine-based cationic polymer (molecular weight ˜8,000 daltons) designated P2350, and a completely hydrolyzed, fully cationized polyvinylamine (molecular weight ˜100,000 daltons) experimental product designated M11-88. As illustrated in Table 4, all amine-containing polymers except for M11-88 caused significant decreases in the bacterial population when used with the VRTX system.

TABLE 4
Changes in population sizes of Escherichia coli in chemically defined
water treated with the indicated product with and without the hydrodynamic water
treatment device.

| | | Total | | | |
|---|---|---|---|---|---|
| | | Treatment | Initial | Final | |
| | Concentration(s) | Time | Population | Population | Percent |
| Treatment | and Contact Time(s) | (min.) | Size | Size | Change |
| Perform ® | 0.5 ppm for 15 min. | 15 | 2.11 × 10⁶ | 1.75 × 10⁶ | −17.06 |
| PC1279 | | | | | |
| Perform ® | 0.5 ppm for 15 min. | 15 | 2.11 × 10⁶ | 1.13 × 10⁶ | −46.45 |
| PC1279 + VRTX | | | | | |
| Perform ® | 0.2 ppm for 10 min, | 40 | 2.17 × 10⁶ | 1.35 × 10⁶ | −37.79 |
| PC8717 | 0.4 ppm for 10 min., | | | | |
| | 0.6 ppm for 10 min., | | | | |
| | 0.8 ppm for 10 min. | | | | |
| Perform ® | 0.2 ppm for 10 min, | 40 | 2.17 × 10⁶ | 2.67 × 10⁵ | −87.69 |
| PC8717 + VRTX | 0.4 ppm for 10 min., | | | | |
| | 0.6 ppm for 10 min., | | | | |
| | 0.8 ppm for 10 min. | | | | |
| Perform ® | 0.2 ppm for 10 min, | 40 | 2.11 × 10⁶ | 1.48 × 10⁶ | −29.86 |
| PC8229 | 0.4 ppm for 10 min., | | | | |
| | 0.6 ppm for 10 min., | | | | |
| | 0.8 ppm for 10 min. | | | | |
| Perform ® | 0.2 ppm for 10 min, | 40 | 2.11 × 10⁶ | 5.17 × 10⁵ | −75.50 |
| PC8229 + VRTX | 0.4 ppm for 10 min., | | | | |
| | 0.6 ppm for 10 min., | | | | |
| | 0.8 ppm for 10 min. | | | | |
| P2350 | 0.05 ppm for 5 min., | 30 | 2.87 × 10⁶ | 1.29 × 10⁶ | −55.05 |
| | 0.10 ppm for 5 min., | | | | |
| | 0.15 ppm for 5 min., | | | | |
| | 0.20 ppm for 5 min., | | | | |
| | 0.25 ppm for 5 min., | | | | |
| | 0.30 ppm for 5 min. | | | | |
| PRP2350 + VRTX | 0.05 ppm for 5 min., | 30 | 2.87 × 10⁶ | 3.12 × 10⁴ | −98.91 |
| | 0.10 ppm for 5 min., | | | | |
| | 0.15 ppm for 5 min., | | | | |
| | 0.20 ppm for 5 min., | | | | |
| | 0.25 ppm for 5 min., | | | | |
| | 0.30 ppm for 5 min. | | | | |
| M11-88 | 0.1 ppm for 5 min., | 25 | 1.62 × 10⁶ | 1.57 × 10⁶ | −3.09 |
| | 0.2 ppm for 5 min., | | | | |
| | 0.3 ppm for 5 min., | | | | |
| | 0.4 ppm for 5 min., | | | | |
| | 0.5 ppm for 5 min. | | | | |
| M11-88 + VRTX | 0.1 ppm for 5 min., | 25 | 1.62 × 10⁶ | 1.95 × 10⁶ | 20.37 |
| | 0.2 ppm for 5 min., | | | | |
| | 0.3 ppm for 5 min., | | | | |
| | 0.4 ppm for 5 min., | | | | |
| | 0.5 ppm for 5 min. | | | | |

### Example 5

In this example, a sample of whitewater from an alkaline, fine papermachine was used in the experimental test system. In this example, the volume of whitewater in the system was 100 gallons. After a 12-minute treatment period, PC1290 was sequentially added at 12-minute intervals for a total treatment time of 60 minutes. As illustrated in Table 5, in the PC1290-treated control, there was no effect on the population size of the whitewater bacteria. However, the water treated with PC1290 and the VRTX system a 93.72% decrease in the population size.

TABLE 5
Changes in population sizes of bacteria in papermill whitewater water
treated with PerForm PC1290 with and without the hydrodynamic water
treatment device.

| | | Total | | | |
|---|---|---|---|---|---|
| | | Treatment | Initial | Final | |
| | Concentration(s) and | Time | Population | Population | Percent |
| Treatment | Contact Time(s) | (min.) | Size | Size | Change |
| PC1290 | 0 ppm for 10 min., | 60 | 1.38 × 10⁷ | 1.37 × 10⁷ | −0.01 |
| | 0.5 ppm for 10 min., | | | | |
| | 1.0 ppm for 10 min., | | | | |
| | 1.5 ppm for 10 min., | | | | |
| | 2.0 ppm for 10 min., | | | | |
| | 3.0 ppm for 10 min. | | | | |
| PC1290 + VRTX | 0 ppm for 10 min., | 60 | 1.38 × 10⁷ | 8.67 × 10⁵ | −93.72 |
| | 0.5 ppm for 10 min., | | | | |
| | 1.0 ppm for 10 min., | | | | |
| | 1.5 ppm for 10 min., | | | | |
| | 2.0 ppm for 10 min., | | | | |
| | 3.0 ppm for 10 min. | | | | |

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

What is claimed is:

1. A method for controlling the growth of microorganisms in water systems comprising the steps of:
a) adding an effective amount of at least one cationic polymer to the water system; and
b) treating the water system with a hydrodynamic-based water treatment device,
to inhibit the growth of the microorganisms.

2. The method of claim 1 wherein the cationic polymer is selected from the group consisting of acrylamide-based polymers.

3. The method of claim 1 wherein the cationic polymer is selected from the group consisting of cationic functionalized polyacrylamides, polyamidoamine-epihalohydrin resins, polyamines, polyimines, polymers with at least one functional group, acrylamide and derivatives thereof; and
quaternary amines.

4. The method of claim 1 wherein the cationic polymer is selected from the group consisting of polymers obtained by polymerization of one or more nonionic monomers followed by derivitization or reaction with another moiety, linear and branched condensation products of epichlorohydrin and amines, polyethylene imine and modified polyethylene imines; and condensation products of cationic ethylenically unsaturated monomers.

5. The method of claim 1 wherein the cationic polymer is selected from the. group consisting of the salts and free bases of: diallydialkylammonium halides, the (meth)acrylates of dialkylaminoalkyl compounds, the N,N-dialkylaminoalkyl(meth)acrylamides, the salt and quaternaries thereof and
mixture of the foregoing and the like; condensation products of the free acids and salts of acrylic acid; methacrylic acid, maleic acid; itaconic acid; acrylamidoglycolic acid; 2-acrylamido-2-methyl-1-propanesulfonic acid; 3-allyloxy-2-hydroxy-1-propanesulfonic acid; styrenesulfonic acid; vinylsulfonic acid; vinylphosphonic acid; 2-acrylamido-2-methylpropane phosphonic acid; and mixtures of any of the foregoing and the like.

6. The method of claim 1, wherein the hydrodynamic-based water treatment device creates hydrodynamic cavitation in the water passing through the hydrodynamic water treatment device.

7. The method of claim 1, wherein the wherein the hydrodynamic-based water treatment device creates shear in the water passing through the hydrodynamic water treatment device.

8. The method of claim 1, wherein the hydrodynamic-based water treatment device creates hydrodynamic cavitation and shear in the water passing through the hydrodynamic water treatment device.

9. The method in claim 1, wherein the cationic polymer has a molecular weight between about 100 and 10,000,000 daltons.

10. The method of claim 1, wherein the amount of polymer added to a water system is in the range of 0.01 to 10,000 mg per liter.

11. The method of claim 1, wherein the cationic polymer is added to the water system before said water system is subjected to treatment with the hydrodynamic treatment device.

12. The method of claim 1 wherein the flowrate through the hydrodynamic-based water treatment device is from about 50 gpm to about 1500 gpm.

13. The method of claim 1 wherein the hydrodynamic-based water treatment operates at a pressure of from about 50 psi to about 200 psi.

14. The method of claim 1, wherein the water system is an industrial water system.

15. The method of claim 1, wherein the water system is a pulp and paper process system.
